(19) United States
(12) Patent Application Publication
(10) Pub. No.: US 2010/0027924 A1
(43) Pub. Date: Feb. 4, 2010

(54) ROUND BEARING

(75) Inventors: Andreas Wulf, Barnstorf (DE); Falk Soeren, Enger (DE); Andreas Horstmann, Sulingen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/514,336

(22) PCT Filed: Nov. 9, 2007
(86) PCT No.: PCT/EP07/62146

§ 371 Date: May 11, 2009

(30) Foreign Application Priority Data
Nov. 16, 2006 (EP) 06124213.7

(51) Int. Cl. F16C 19/00; B21D 53/10

(52) U.S. Cl. 384/91; 29/898.12

(57) ABSTRACT

A method for producing bearings comprising (i) an outer bushing, (ii) a bearing element based on cellular polyisocyanate polyadducts and (iii) a hollow inner bushing, wherein the outer bushing is produced by casting or injecting a reactive polyurethane system and adhesively bonding it to the bearing element.

The invention relates to a method for producing preferably cylindrical bearings, preferably round bearings comprising (i) preferably a cylindrical outer bushing, (ii) preferably a cylindrical preferably resilient bearing element based on cellular polyisocyanate polyadducts and (iii) a hollow preferably cylindrical inner bushing, the outer bushing being produced by casting or injecting a reactive polyurethane system and adhesively bonding it to the bearing element. Furthermore, the invention relates to bearings obtainable in this manner and automobiles or trucks comprising the round bearings according to the invention.

Round bearings are used within the chassis in automobiles and are generally known. With the aid of round bearings, assemblies, chassis components, etc. are connected to one another or to the bodywork in the automobile. By the use of elastomer materials, they perform the function of elastic mounting; secondly, owing to their viscous properties, they are capable of dissipating energy and thus damping vibrations. A high degree of damping is required, particularly for attenuating large amplitudes of low-frequency vibrations which influence, for example, the connection of the shock absorber to the bodywork. On the other hand, high damping is undesired in the case of small amplitudes and higher frequencies, for reasons relating to vehicle acoustics. The damping behavior of such conventional round bearings is dependent on the intrinsic damping capability of the elastomer material used. Such round bearings are described in WO 03/104677, WO 03/104345, WO 03/104326 and WO 03/104676.

Particular requirements furthermore exist in the development of a production method which is as economical as possible and permits the manufacture of as wide a variety as possible of different round bearings in a reliable, flexible and fast manner.

It was therefore an object of the present invention to develop a method for producing preferably cylindrical bearings, preferably round bearings, comprising (i) a preferably cylindrical outer bushing, (ii) a preferably cylindrical preferably resilient bearing element based on cellular polyisocyanate polyadducts and (iii) a hollow preferably cylindrical inner bushing, by means of which said problems and requirements are solved. In particular, the method should be suitable, independently of the production of the bearing element, for producing round bearings based on a differential design.

These objects could be achieved by producing the outer bushing by casting or injecting a reactive polyurethane system and adhesively bonding it to the bearing element.

The present invention is distinguished in that the outer bushing is produced by means of a reactive polyurethane system, which can be processed by means of the generally known RIM technique (reaction injection molding) or as a conventional casting system. This has the advantage that there is a considerable degree of freedom regarding the design of the outer bushing and that no adhesion promoter as for the use of metal outer bushing materials need be used. Furthermore, the differential design permits quality assurance in the early stage of the assembly process. In addition, the deformation of the cellasto is very low because of the comparatively low pressure when filling the mold. Furthermore, the bonding with the core or a further outer shell can be effected at the same time.

The method according to the invention is preferably effected in a manner such that the bearing element (ii) is produced in contact with the inner bushing, preferably foamed and adhesively bonded, and the outer bushing (i) is then produced with the reactive polyurethane system. Alternatively, in a further preferred embodiment, it is possible to place the inner bushing (iii) in the bearing element (ii) and to adhesively bond it, preferably cement it, and then to produce the outer bushing (i) with the reactive polyurethane system. Furthermore, the bonding of the core to the bearing element and the production of the outer bushing can be effected simultaneously. In other words, a method in which the outer shell (i) is produced by casting or injecting the reactive polyurethane system and, in the same operation, the bearing element (ii) is adhesively bonded to the inner bushing (iii) is furthermore preferred.

Suitable reactive polyurethane systems which can be processed as casting systems or by means of RIM technology to give the outer bushing are generally known and commercially available. The outer bushing is preferably produced by means of reaction injection molding (RIM).

Fiber-reinforced reactive polyurethane systems, preferably those which are reinforced with glass fibers, carbon fibers or aramid fibers, particularly preferably with glass fibers, are preferably used.

Preferably, the bearing element (ii) is produced, preferably foamed and adhesively bonded, in contact with the inner bushing, and the outer bushing (i) is then produced in contact with the bearing element (ii). Alternatively, the inner bushing (iii) can be placed in the bearing element (ii) and adhesively bonded, preferably cemented, and the outer bushing (i) is then produced in contact with the bearing element (ii).

In addition to the bearing element (ii), at least one further bearing may be present between inner bushing and outer bushing in the bearing according to the invention. This additional bearing (iv) is preferably a resilient material. The additional bearing serves as an additional functional material for adjusting the rigidity of the bearing in different radial directions in a targeted manner. For this reason, the additional bearing is preferably not used over the total circumference of the bearing. The bearing element (iv) preferably has a spring characteristic differing from that of the bearing element (ii). This can be achieved by using a fundamentally different material or by varying, for example, the density in comparison with the other bearing element (ii). The bearing element (ii) is preferably adhesively bonded to at least one further resilient bearing element (iv), particularly preferably two further resilient bearing elements (iv). The bearing element (iv) is preferably placed between the outer bushing (i) and the bearing element (ii). The bearing element (iv) extends axially preferably over the total length of the bearing element (ii). Preferably, the bearing element (ii) is not completely surrounded by the bearing element.

Alternatively, the bearing element (iv) can be placed between the inner bushing (iii) and the bearing element (ii), may extend axially over the total length of the bearing element (ii) and may not completely surround the inner bushing (iii). The bearing element (iv) is particularly preferably arranged in at least one, preferably 2, groove(s) of the bearing element (ii), which grooves are preferably opposite one another.

The bearing element (iv) can preferably be produced by means of injection molding in contact with the bearing element (ii). Thermoplastic polyurethane is particularly preferably used, preferably having a hardness of from 50 to 70 Shore A. The injection molding of thermoplastic polyurethane and also the thermoplastic polyurethane itself are generally known.

Alternatively, the bearing element (iv) can be produced as a cast elastomer in contact with the bearing element (ii). Suitable cast elastomers are in particular generally known cast polyurethane elastomers which are commercially available. These cast elastomers preferably have a hardness of from 50 to 70 Shore A. Thereafter, after curing of the cast elastomer, the outer bushing can be produced by means of injection molding.

The outer bushing preferably has a thickness of from 1 mm to 10 mm.

The surface of the bearing element (ii) can be pretreated for improving the adhesion by generally known methods. Preferably, the surface is plasma-treated and the reactive polyurethane system is then cast or injected onto the pretreated surface of the bearing element. Alternatively and likewise preferably, it is possible to pretreat the surface of the bearing element (ii) mechanically and then to cast or to inject the reactive polyurethane system onto the pretreated surface of the bearing element.

The inner bushing (iii) may be based on customary materials, for example metals, e.g. steel, iron and/or aluminum, or rigid plastics, e.g. TPU. The inner bushing (iii) has an inner bore, usually for receiving a fastening bolt. The external diameter is determined by strength considerations. The inner bushing is preferably based on metal.

The bearing element (ii) according to the invention is preferably based on polyisocyanate polyadducts, for example polyurethanes and/or polyureas, for example polyurethane elastomers which, if appropriate, may comprise urea structures, preferably cellular polyurethane elastomers, preferably having a density, according to DIN EN ISO 845, of from 200 to 800 kg/m³, preferably from 300 to 600 kg/m³, a tensile strength, according to DIN EN ISO 1798 of ≧2.0 N/mm², preferably ≧2.5 N/mm², particularly preferably from 2.5 to 8 N/mm², an elongation at break, according to DIN EN ISO 1798, of ≧200%, preferably ≧350%, and a tear propagation strength, according to DIN ISO 34-1 B, b, of ≧8 N/mm, preferably from 8 to 25 N/mm. The elastomers are preferably microcellular elastomers based on polyisocyanate polyadducts, preferably with cells having a diameter of from 0.01 mm to 0.5 mm, particularly preferably from 0.01 to 0.15 mm. The elastomers particularly preferably have the physical properties described at the outset. Elastomers based on polyisocyanate polyadducts and their preparation are generally known and have been widely described, for example in EP-A 062 835, EP-A 036 994, EP-A 250 969, DE-A 195 48 770 and DE-A 195 48 771. The preparation is usually effected by reacting isocyanates with compounds reactive toward isocyanates. The elastomers based on cellular polyisocyanate polyadducts are usually produced in a mold in which the reactive starting components are reacted with one another. Suitable molds here are generally customary molds, for example metal molds, which, owing to their shape, ensure the three-dimensional shape according to the invention of the spring element. The preparation of the polyisocyanate polyadducts can be effected by generally known processes, for example by using the following starter materials in a one-stage or two-stage process:
(a) isocyanate,
(b) compounds reactive toward isocyanates,
(c) water and, if appropriate,
(d) catalysts,
(e) blowing agents and/or
(f) assistants and/or additives, for example polysiloxanes and/or fatty acid sulfonates.

The cellular polyisocyanate polyadducts preferably have a compressive set of less than 25% according to DIN 53572, test specimens used being cubes having the dimensions 40 mm×40 mm×30 mm without a silicone coat, the test being effected at constant deformation, the test specimens being compressed by 40% and being kept in a through-circulation oven for 22 hours at 80° C., the test device being cooled to room temperature for 2 hours in the compressed state after removal from the oven, the test specimen then being removed from the test device and the height of the test specimens being measured accurately to 0.1 mm 10 min±30 s after removal of the test specimens from the test device. The bearing element (ii) is preferably adhesively bonded to the outer bushing (i) and/or the inner bushing (iii). The expression “adhesively bonded” is to be understood as meaning in particular that the bearing element (ii) is cemented to the inner bushing (iii), for example with generally customary adhesives, or is produced as a foam by direct expansion on the inner bushing (iii).

The bearing element (ii) and, if appropriate, (iv) are arranged between inner bushing (iii) and outer bushing (i). The individual elements outer bushing, bearing element and inner bushing are preferably adhesively bonded to one another.

The dimensions of inner bushing, bearing elements and outer bushing can be chosen substantially arbitrarily and preferably depend on the dimensions of known round bearings. The length of the round bearing and the total diameter and the diameter of the cavity in the inner bushing (i) may depend on the use and on the objects to be mounted. The choice of suitable dimensions is familiar to the person skilled in the art. The preferred dimensions of the inner bushing were described at the outset.

The inner bushing (i) preferably has a height of from 30 mm to 100 mm, an external diameter of from 20 mm to 80 mm and preferably a cavity diameter of from 8 mm to 20 mm.

Suitable objects which are to be mounted by means of the round bearing, in particular on the bodywork of an automobile or of a truck, are, for example, all types of assemblies, subframes, connecting rods, gears and/or add-on parts, preferably assemblies, connecting rods and/or gears, particularly preferably rear-axle gears.

These parts to be mounted using the round bearing which preferably has a damping effect can be fastened to the round bearing, for example, in such a way that they are fastened with the aid of screw, bolt, pin, rivet or other interlocking or frictional connections, preferably screw, bolt, pin or rivet connections, preferably with the aid of the hollow inner bushing.

Assemblies, connecting rods and/or gears, particularly preferably rear-axle gears, are preferably appropriately fastened to the inner bushing (i) and thus preferably connected to the bodywork of an automobile or of a truck, preferably in a vibration-damping manner. It is also conceivable for these bearings to be introduced, for example, into the end plates of gears or assemblies, which are then connected to the bodywork.

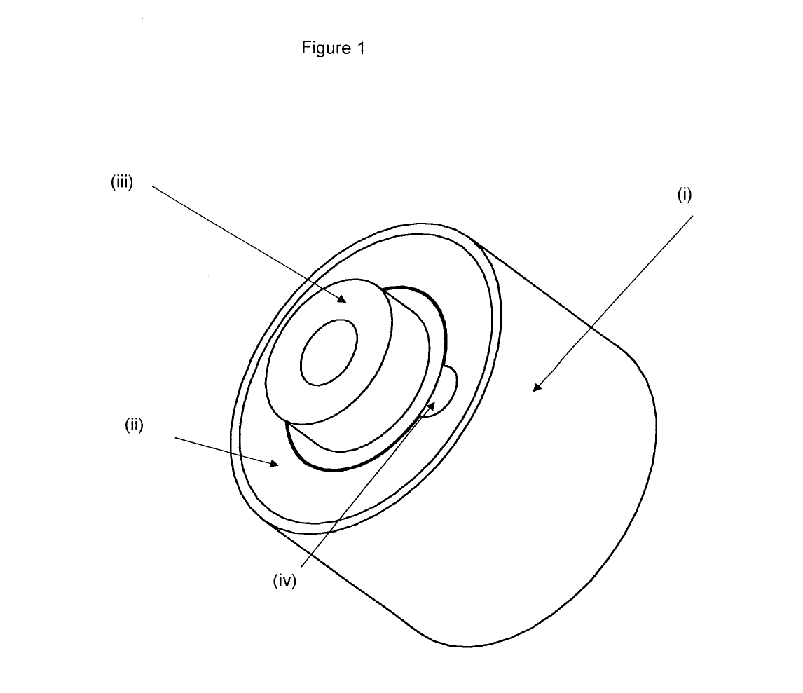

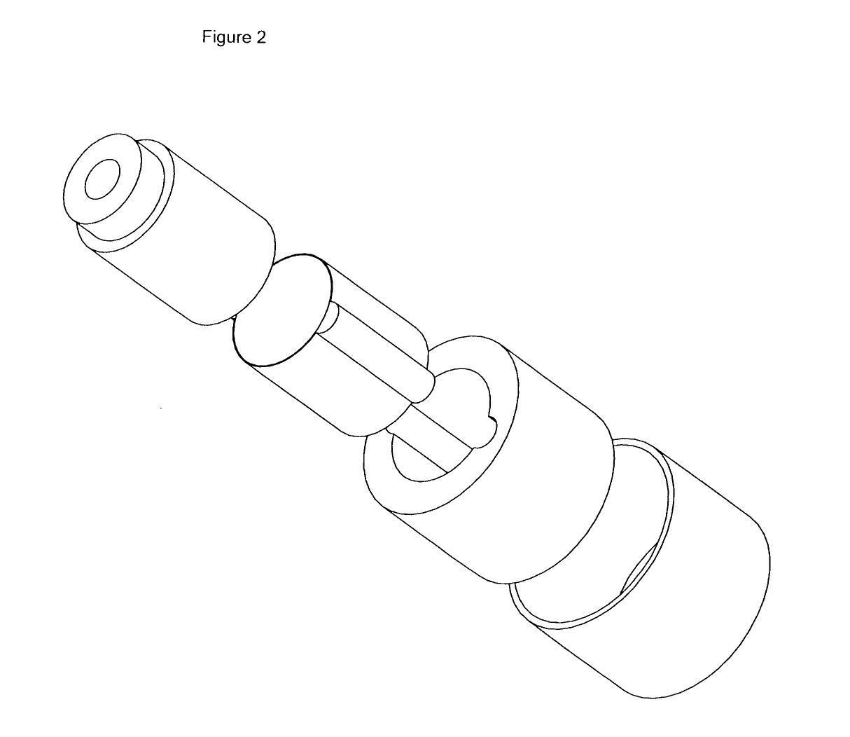

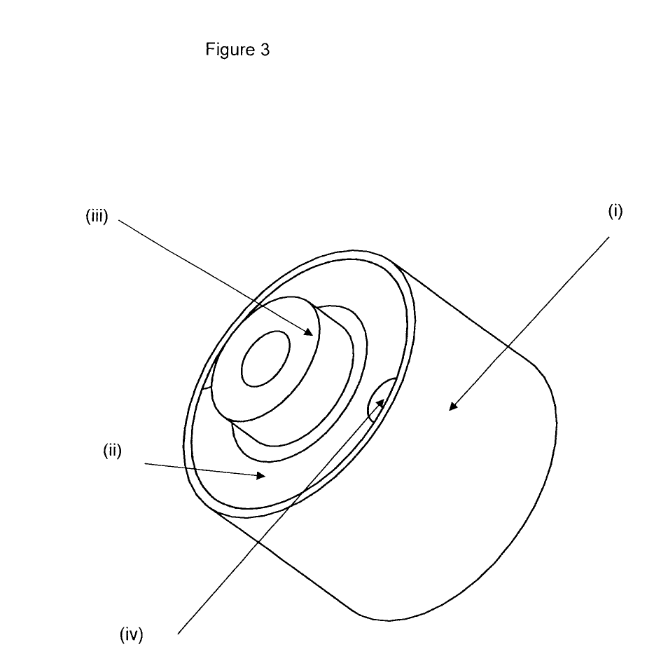

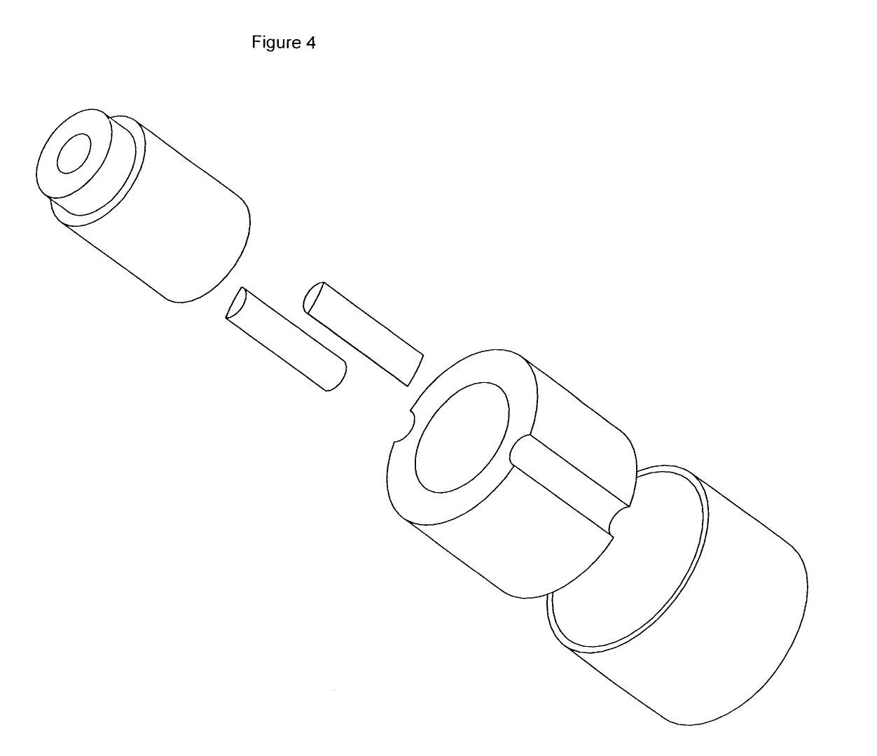

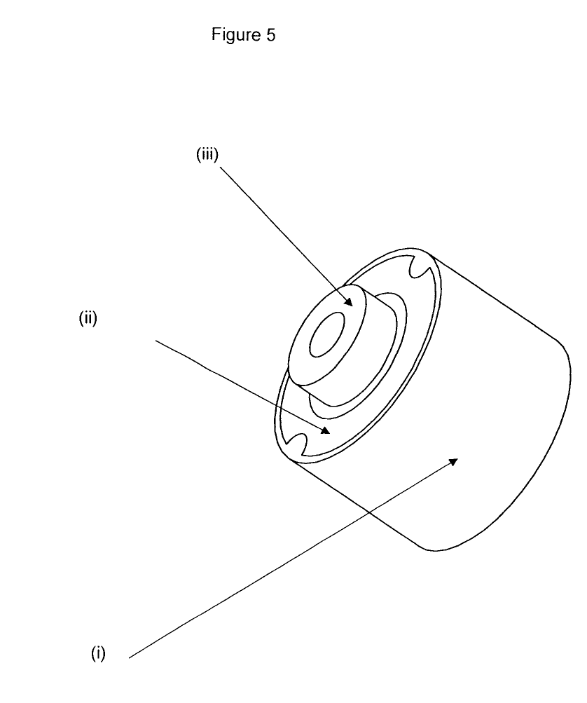

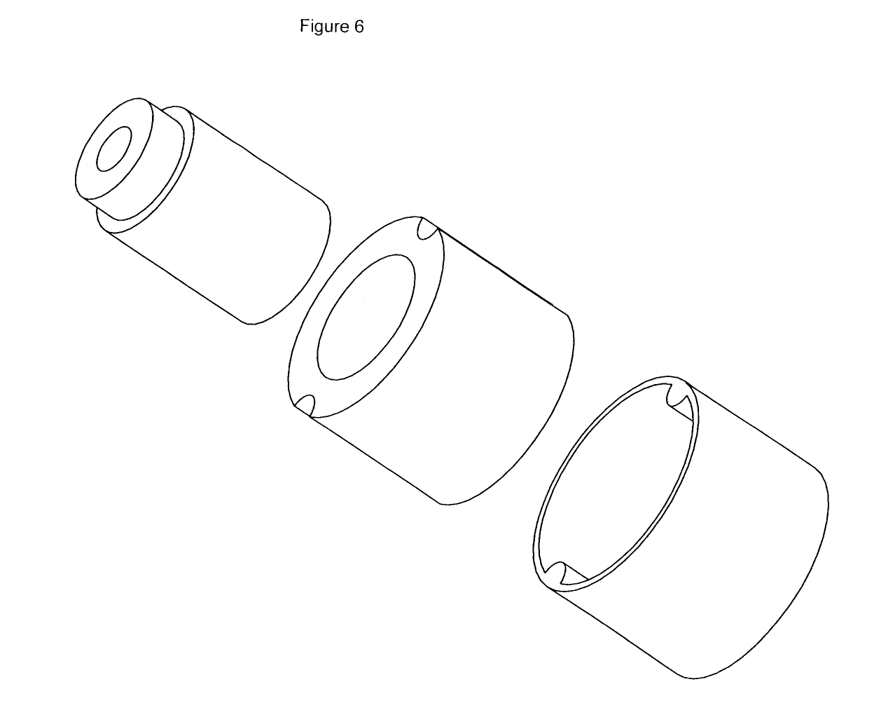

A round bearing according to the invention is shown in FIGS. 1 to 6. There, the outer bushing is characterized by (i), the inner bushing by (iii) and the bearing elements by (ii) and (iv). For greater clarity, the round bearing is shown partly in the individual parts, i.e. dismantled.

1. A method for producing bearings comprising (i) an outer bushing, (ii) a bearing element based on cellular polyisocyanate polyadducts and (iii) a hollow inner bushing, wherein the outer bushing is produced by casting or injecting a reactive polyurethane system and adhesively bonding it to the bearing element.

2. The method according to claim 1, wherein the outer bushing (i) is produced by reaction injection molding (RIM).

3. The method according to claim 1, wherein the reactive polyurethane system is fiber-reinforced.

4. The method according to claim 1, wherein the bearing element (ii) is produced in contact with the inner bushing, and the outer bushing (i) is then produced in contact with the bearing element (ii).

5. The method according to claim 1, wherein the inner bushing (iii) is placed in the bearing element (ii) and adhesively bonded to it by reaction injection molding (RIM), and the outer bushing (i) is then produced in contact with the bearing element (ii).

6. The method according to claim 1, wherein the outer shell (i) is produced by the casting or injection of the reactive polyurethane system and, in the same operation, the bearing element (ii) is adhesively bonded to the inner bushing (iii).

7. The method according to claim 1, wherein the bearing element (ii) is adhesively bonded to a further resilient bearing element (iv).

8. The method according to claim 7, wherein the bearing element (iv) is placed between the outer bushing (i) and the bearing element (ii), extends axially over the total length of the bearing element (ii) and does not completely surround the bearing element (ii).

9. The method according to claim 7, wherein the bearing element (iv) is placed between the inner bushing (iii) and the bearing element (ii), extends axially over the total length of the bearing element (ii) and does not completely surround the inner bushing (iii).

10. The method according to claim 8, wherein the bearing element (iv) is arranged in at least one groove of the bearing element (ii).

11. The method according to claim 7, wherein the bearing element (iv) is produced by means of injection molding in contact with the bearing element (ii).

12. The method according to claim 7, wherein the bearing element (iv) is produced as a cast elastomer in contact with the bearing element (ii).

13. The method according to claim 1, wherein the outer bushing has a thickness of from 1 mm to 10 mm.

14. The method according to claim 1, wherein the surface of the bearing element (ii) is plasma-treated and the reactive polyurethane system is then cast or injected onto the pretreated surface of the bearing element.

15. The method according to claim 1, wherein the surface of the bearing element (ii) is mechanically pretreated and the reactive polyurethane system is then cast or injected onto the pretreated surface of the bearing element.

16. A bearing obtainable by a method according to claim 1.
